(19) United States
(12) Patent Application Publication
(10) Pub. No.: US 2009/0141011 A1
(43) Pub. Date: Jun. 4, 2009

(54) Systems and Methods for Driving Multiple Displays Using a Common Display Driver

(75) Inventors: Karl F. Greb, Missouri City, TX (US); Nicholas H. Schutt, Houston, TX (US)

Correspondence Address: TEXAS INSTRUMENTS INCORPORATED, P O BOX 655474, M/S 3999, DALLAS, TX, 75265, US

(73) Assignee: Texas Instruments Incorporated

(21) Appl. No.: 11/949,830

(22) Filed: Dec. 4, 2007

(51) Int. Cl. G06F 3/038

(52) U.S. Cl. 345/206

(57) ABSTRACT

Various systems and methods for implementing multi-display driver systems are disclosed. As one example, a display system is disclosed that includes a display driver, a processor, a computer readable medium, and a splitter device. The computer readable medium includes instructions executable by the processor to configure the display driver to provide a display output set for a virtual display. The splitter device is operable to receive at least a portion of a display output set, and to provide a first display output to drive a first display and a second display output to drive a second display based on the portion of the display output set.

### BACKGROUND OF THE INVENTION

The present invention is related to display drivers, and more particularly to approaches for utilizing single display driver chips to drive multiple displays.

Various chips have been developed to drive multiple displays. FIG. 1 shows one exemplary multi-display driver 100. Multi-display driver 100 includes two LCD drivers 110 that can each be separately programmed to drive respective displays 130. Further, each of LCD drivers 110 may be designed to operate from its own memory buffer 120. Such an approach allows for a great deal of flexibility in driving multiple displays as each of LCD drivers may be programmed to drive according to the particular characteristics of the display to be driven. Unfortunately, such an approach involves a product that may require substantially more area and cost than that required to drive only a single display. Further, such approaches do not allow for the use of existing single display drivers that may be both commonly available and relatively inexpensive.

Thus, for at least the aforementioned reason, there exists a need in the art for advanced systems and methods for utilizing single display drivers to drive multiple displays.

### BRIEF SUMMARY OF THE INVENTION

The present invention is related to display drivers, and more particularly to approaches for utilizing single display driver chips to drive multiple displays.

Various embodiments of the present invention provide multi-display driver systems. Such systems include a display driver, a processor, a computer readable medium, and a splitter device. The computer readable medium includes instructions executable by the processor to configure the display driver to provide a display output set for a virtual display. The splitter device is operable to receive at least a portion of a display output set, and to provide a first display output to drive a first display and a second display output to drive a second display based on the portion of the display output set. In some instances of the aforementioned embodiments, the display driver is capable of driving only a single display. Further, in some instances of the aforementioned embodiments, the display output set includes display data, and the splitter device includes a first FIFO memory for storing a first portion of the display data for the first display and a second FIFO memory for storing a second portion of the display data for the second display.

In particular instances of the aforementioned embodiments, the virtual display is a double wide, single high display, and configuring the display driver to provide the display output set for the virtual display includes configuring the display driver to drive a single wide, double high display. In such instances, the display output set may include a virtual horizontal sync. The device splitter may assert a first horizontal sync for the first display upon a first assertion of the virtual horizontal sync and assert a second horizontal sync for the second display upon a second assertion of the virtual horizontal sync.

In other particular instances of the aforementioned embodiments, the virtual display is a single wide, double high display, and configuring the display driver to provide the display output set for the virtual display includes configuring the display driver to drive a single wide, single high display. In such instances, the display output set may include a virtual vertical sync. The device splitter asserts a first vertical sync for the first display upon a first assertion of the virtual vertical sync and asserts a second vertical sync for the second display upon a second assertion of the virtual vertical sync.

In yet other particular instances of the aforementioned embodiments, the display output set includes a virtual horizontal sync and a virtual vertical sync. The virtual display is a first virtual display, and the computer readable medium further includes instructions executable by the processor to: re-configure the display driver to provide the display output set for a second virtual display upon a preceding assertion of the virtual vertical sync; and re-configure the display driver to provide the display output set for the first virtual display upon a subsequent assertion of the virtual vertical sync. In such instances, the device splitter may assert a first vertical sync for the first display that corresponds to the subsequent assertion of the virtual vertical sync, and assert a second vertical sync for the second display that corresponds to the preceding assertion of the virtual vertical sync.

In yet further particular instances of the aforementioned embodiments, the virtual display is a double wide, single high display, and configuring the display driver to provide the display output set for the virtual display includes configuring the display driver to drive a double wide, single high display. In such instances, the display output set may include a virtual display clock. The device splitter asserts a first display clock for the first display upon a preceding assertion of the virtual display clock and asserts a second display clock for the second display upon a subsequent assertion of the virtual display clock.

Other embodiments of the present invention provide methods for driving multiple displays. Such methods include providing a display driver that is capable of driving only a single display. The display driver is configure to provide a display output set for a virtual display. Based on a portion of the display output set, a first display output is provided to drive a first display and a second display output is provided to drive a second display. In such cases, the first display content may be different from the second display content.

In particular instances of the aforementioned embodiments, the virtual display is a double wide, single high display, and configuring the display driver to provide the display output set for the virtual display includes configuring the display driver to drive a single wide, double high display. The display output set includes a virtual horizontal sync. Providing the first display output includes asserting a first horizontal sync for the first display upon a first assertion of the virtual horizontal sync, and providing the second display output includes asserting a second horizontal sync for the second display upon a second assertion of the virtual horizontal sync.

In other particular instances of the aforementioned embodiments, the virtual display is a single wide, double high display, and configuring the display driver to provide the display output set for the virtual display includes configuring the display driver to drive a single wide, single high display. The display output set includes a virtual vertical sync. Providing the first display output includes asserting a first vertical sync for the first display upon a first assertion of the virtual vertical sync, and providing the second display output includes asserting a second vertical sync for the second display upon a second assertion of the virtual vertical sync.

In yet other particular instances of the aforementioned embodiments, the display output set includes a virtual horizontal sync and a virtual vertical sync, and two distinct virtual displays are supported. The methods further include: re-configuring the display driver to provide the display output set for a second virtual display upon a preceding assertion of the virtual vertical sync; and re-configuring the display driver to provide the display output set for the first virtual display upon a subsequent assertion of the virtual vertical sync. In such cases, providing the first display output includes asserting a first vertical sync for the first display that corresponds to the subsequent assertion of the virtual vertical sync; and providing the second display output includes asserting a second vertical sync for the second display that corresponds to the preceding assertion of the virtual vertical sync.

In yet further particular instances of the aforementioned embodiments, the virtual display is a double wide, single high display, and configuring the display driver to provide the display output set for the virtual display includes configuring the display driver to drive a double wide, single high display. The display output set includes a virtual display clock. Providing the first display output includes asserting a first display clock for the first display upon a first assertion of the virtual display clock, and providing the second display output includes asserting a second display clock for the second display upon a subsequent assertion of the virtual display clock.

Yet other embodiments of the present invention provide computer readable media that includes instructions executable by a processor to configure a display driver to provide a display output set for a virtual display. The display driver is capable of driving only a single display, and the display output is modifiable to drive at least a first display and a second display. In some instances of the aforementioned embodiments, the virtual display is a double wide, single high display, and configuring the display driver to provide the display output set for the virtual display includes configuring the display driver to drive a double wide, single high display. In such cases, the display output set includes a virtual display clock that is asserted to the first display on one cycle and to the second display on another cycle. In other instances of the aforementioned embodiments, the virtual display is a double wide, single high display, and configuring the display driver to provide the display output set for the virtual display includes configuring the display driver to drive a single wide, double high display. In such cases, the display output set includes a virtual horizontal sync; and the virtual horizontal sync is asserted to the first display on one cycle and to the second display on another cycle.

This summary provides only a general outline of some embodiments according to the present invention. Many other objects, features, advantages and other embodiments of the present invention will become more fully apparent from the following detailed description, the appended claims and the accompanying drawings.

### BRIEF DESCRIPTION OF THE DRAWINGS

A further understanding of the various embodiments of the present invention may be realized by reference to the figures which are described in remaining portions of the specification. In the figures, like reference numerals are used throughout several drawings to refer to similar components. In some instances, a sub-label consisting of a lower case letter is associated with a reference numeral to denote one of multiple similar components. When reference is made to a reference numeral without specification to an existing sub-label, it is intended to refer to all such multiple similar components.

FIG. 1 depicts a prior art two display driver chip;

FIG. 2 depicts an existing single display driver chip configured to drive two or more displays in accordance with some embodiments of the present invention;

FIGS. 3a-3b depict a method in accordance with one or more embodiments of the present invention for utilizing an existing single display driver chip to drive two or more displays;

FIGS. 4a-4b depict another method in accordance with some embodiments of the present invention for utilizing an existing single display driver chip to drive two or more displays;

FIGS. 5a-5b depict yet another method in accordance with various embodiments of the present invention for utilizing an existing single display driver chip to drive two or more displays;

FIGS. 6a-6b depict yet a further method in accordance with some embodiments of the present invention for utilizing an existing single display driver chip to drive two or more displays; and

FIG. 7 depicts an existing single display driver chip configured to drive two or more displays via FIFO memories in accordance with other embodiments of the present invention.

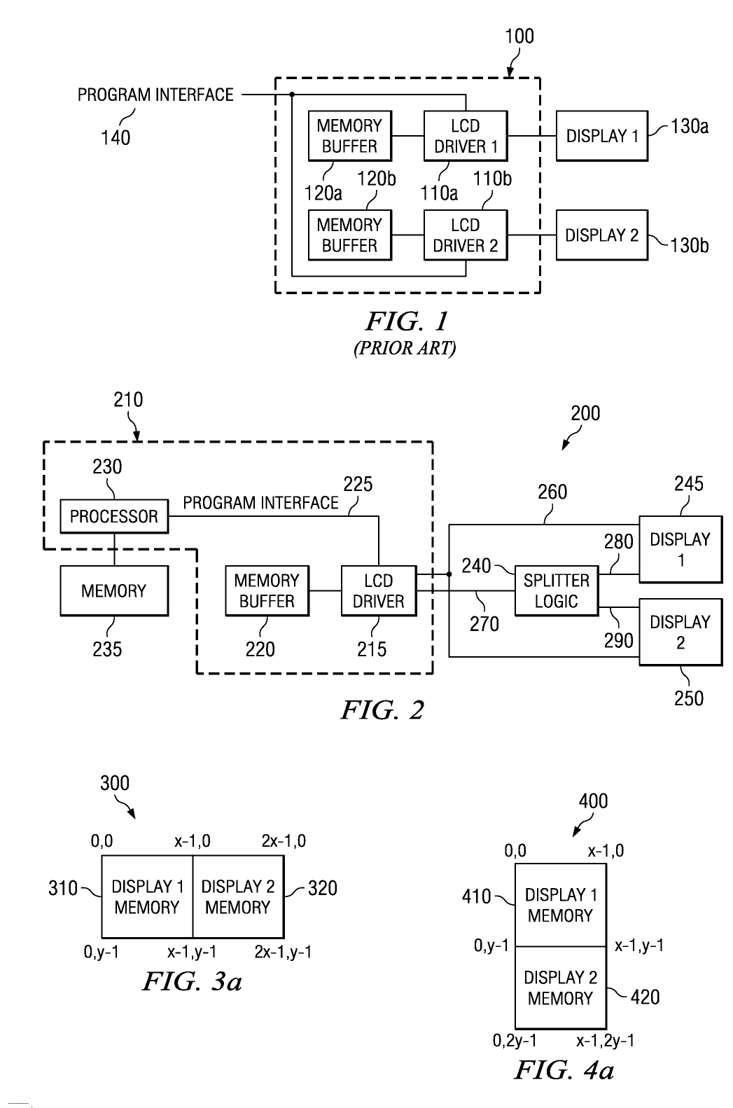

### DETAILED DESCRIPTION OF THE INVENTION

The present invention is related to display drivers, and more particularly to approaches for utilizing single display driver chips to drive multiple displays.

Turning to FIG. 2, a display system 200 including an existing single display driver chip 210 configured to drive two or more displays 245, 250 is depicted in accordance with some embodiments of the present invention. Single display driver chip 210 includes an LCD driver 215 and a memory buffer 220 as indicated by the dashed line. In some cases, a processor 230 and/or a memory 235 may also be incorporated on the same chip as LSC driver 215. LCD driver 215 is programmable by processor 230 via a program interface 225. Such programming may be accomplished through use of any of a number of programming approaches and interfaces known in the art and consistent with the requirements of LCD driver 215, and may be accomplished by executing one or more instructions that are maintained in a memory 235. Such instructions may be executable by processor 230 and/or LCD driver 215, and may be, for example, software or firmware instructions. It should be noted that memory 235 may be any form or combination of computer readable media including, but not limited to, a hard disk drive, a random access memory, a flash memory, a removable magnetic storage media, a CD ROM, combinations of he aforementioned and/or the like. LCD driver 215 provides a display output set that includes both a display data portion and one or more timing signals. Such timing signals may include, but are not limited to, a horizontal sync signal, a vertical sync signal and a display clock. Based on the disclosure provided herein, one of ordinary skill in the art will recognize a variety of timing signals and display data that may be included in a display output set provided by LCD driver 215. In different embodiments of the present invention, one portion 260 of the display output set is driven directly to both display 245 and display 250. Another portion 270 of the display output set is driven indirectly to both display 245 and display 250 via a splitter logic circuit 240 also referred to herein as a splitter device.

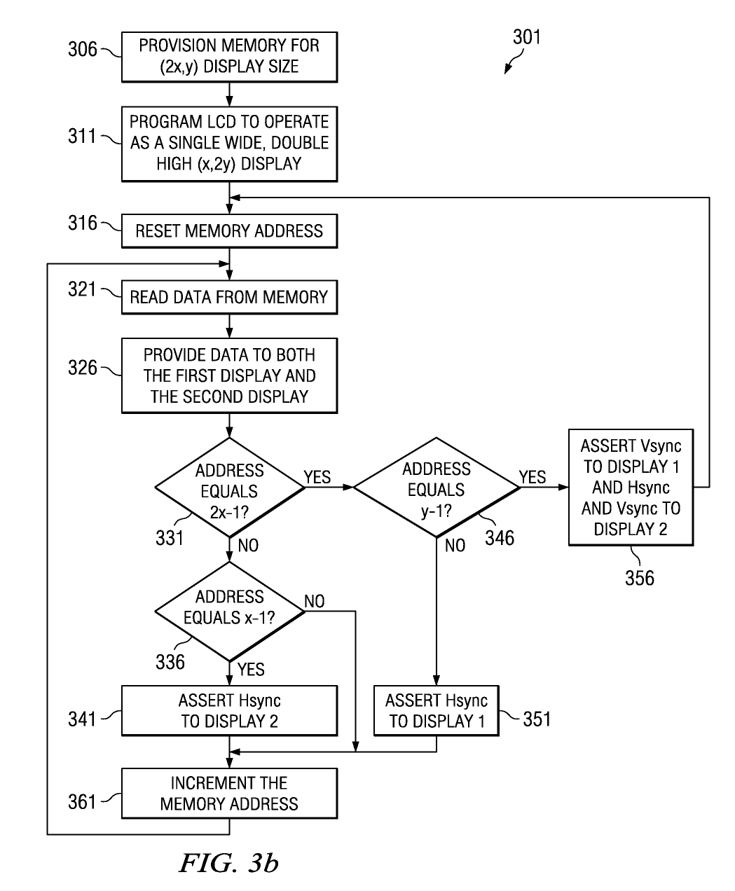

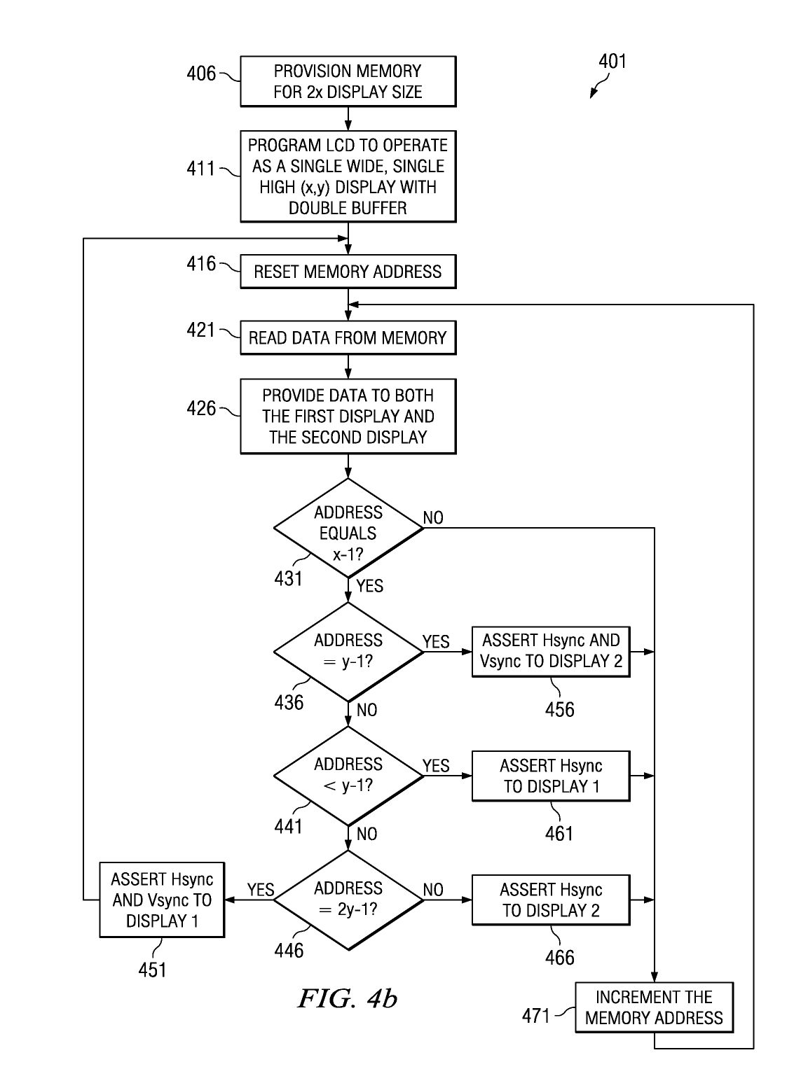

Display system 200 may be configured in a variety of novel ways to allow existing single display driver chip 210 to support two or more displays. Four different approaches are described below in relation to FIGS. 4-6, but it should be noted that other approaches may be possible in accordance with different embodiments of the present invention. Turning to FIGS. 3a-3b, a method in accordance with one or more embodiments of the present invention for utilizing an existing single display driver chip 210 to drive two or more displays is discussed. The method operates through defining a virtual display 300. Virtual display 300 is a memory buffer that is defined to maintain a display memory for a first display 310, and a display memory for a second display 320 virtually positioned horizontally next to first display 310. Thus, where virtual display 300 is defined to be of a dimension X-width and Y-height, the memory buffer is a size 2X*Y. It should be noted that while virtual display 300 is shown as a rectangular memory area, that a linear or other memory area of the above mentioned size may be utilized in accordance with different embodiments of the present invention. Virtual display 300 is defined within memory buffer 220 as a double wide, single high display.

In combination with virtual display 300, LCD driver 215 is programmed by processor 230 to operate on a single wide, double high display. This causes LCD driver 215 to assert a horizontal sync at the half way point of each display line (i.e., addresses [x−1, 0], [x−1, 1] . . . [x−1,y]), and at the completion of each display line (i.e., addresses [2x, 0], [2x, 1] . . . [2x,y]). In such a configuration, the display data and the vertical sync timing signal are provided directly from LCD driver 215 to display 245 and display 250. In contrast, the display clock and the horizontal sync timing signals from LCD driver 215 are provided indirectly to display 245 and display 250 via splitter logic circuit 240. In operation, the display clock is passed to display 245 for the first half of the display line (i.e., addresses 0 to x−1) and gated from display 250 for the same period, and passed to display 250 for the second half of the display line (i.e., addresses x to 2x−1) and gated from display 245 for the same period. Similarly, horizontal syncs generated for the first half of the display line (i.e., addresses [x−1, y−1]) are passed to display 245, and horizontal syncs generated for the second half of the display line (i.e., addresses [2x−1, y−1]) are passed to display 250.

It should be noted that some displays may effectively ignore the display clock when horizontal and vertical syncs are not received. For example, a display may clock in a defined number of display data (i.e., pixels) after reception of a horizontal sync, but ignore display data received in excess of the defined number. In such a circumstance, it may not be necessary to gate the display clock to the particular display. Alternatively, in some cases a display may ignore horizontal and vertical syncs that are not received with an active display clock. In such instances, by gating the display clock to a particular display it would not be necessary to also gate the horizontal and vertical syncs to the display. The aforementioned embodiments of the present invention may be described as having a device splitter that asserts a first horizontal sync for the first display upon a first assertion of the virtual horizontal sync and asserts a second horizontal sync for the second display upon a second assertion of the virtual horizontal sync. Such language is used in its broadest sense to mean any situation where a horizontal sync is alternated between multiple displays. Thus, this may include, but is not limited to: (1) asserting the horizontal sync to display 245 on one assertion of the horizontal sync provided by LCD driver 215 and not to display 250, and asserting the horizontal sync to display 250 on a subsequent assertion of the horizontal sync provided by LCD driver 215 and not to display 245; (2) providing the display clock from LCD driver 215 to display 245 during one assertion of the horizontal sync and gating the display clock to display 250 during the same period, and providing the display clock from LCD driver 215 to display 250 during a subsequent assertion of the horizontal sync and gating the display clock to display 245 during the same period; and (3) gating both the horizontal sync and the display clock to display 245 during one period and not to display 250 during the same period, and gating both the horizontal sync and the display clock to display 250 during a subsequent period and not to display 245 during the same period. Based on the disclosure provided herein, one of ordinary skill in the art will recognize a variety of other approaches that may be used to assert a horizontal sync to one device and not the other, and then asserting the horizontal sync to the other display during a subsequent period.

Turning to FIG. 3b, a flow diagram 301 graphically displays the above described process. Following flow diagram 301, memory buffer 220 is provisioned to hold a 2X*Y memory (block 306). This is the double wide, single high virtual display. In addition, LCD driver 215 is programmed to treat virtual display 300 as a unified single wide, double high display (block 311). The memory address to memory buffer 220 is reset to the beginning of the display memory for a first display 310 (block 316). Display data from the beginning address is then read from memory buffer 220 and provided to both display 245 and display 250 (blocks 321, 326). The display clock may be, however, only passed through to display 245 during access to display memory 310, and only to display 250 during access to display memory 320. It is then determined whether the address is the last address in a line of virtual display 300 (i.e., 2x−1) (block 331). Where it is determined that the address is the last address in the line (block 331), it is determined whether the address is the last address of virtual display 300 (i.e., 2x−1,y−1) (block 346). Where the address is the last address of virtual display 300 (block 346), the vertical sync from LCD driver 215 is passed to both display 245 and display 250; the horizontal sync is passed from LCD driver 215 by splitter logic circuit 240 to display 250; and the memory address is reset (block 316). In contrast, where the address is not the last address of virtual display 300 (i.e., the x address is at a maximum, but the y address is not) (block 346), the horizontal sync is passed from LCD driver 215 by splitter logic circuit 240 to display 245 (block 351), the address is incremented (block 361), and the next display data is read from memory buffer 220 (block 321).

Alternatively, where it is determined that the address is not the last address in the line (block 331), it is determined whether the address is the mid-address in the line (i.e., x−1) (block 336). Where it is determined that the address is the mid-address in the line (block 336), the horizontal sync is passed from LCD driver 215 by splitter logic circuit 240 to display 250 (block 341), the address is incremented (block 361), and the next display data is read from memory buffer 220 (block 321). In contrast, where it is determined that the address is not the mid-address in the line (block 336), the address is incremented (block 361), and the next display data is read from memory buffer 220 (block 321).

As just some of the advantages of the embodiments discussed in relation to FIGS. 3a-3b, LCD driver 215 treats virtual display 300 as one large screen in memory, and provides a relatively simple implementation. It should be noted that the display clock is an Nx clock for a given display refresh rate where N represents the number of displays driven. In some cases, splitter logic circuit 240 may include buffers that may be used to re-time display data and/or timing signals to provide desired setup and hold times in relation to the display clock.

Turning to FIGS. 4a-4b, another method in accordance with some embodiments of the present invention for utilizing existing single display driver chip 210 to drive two or more displays is discussed. The method operates through defining a virtual display 400. Virtual display 400 is a memory buffer that is defined to maintain a display memory for a first display 410, and a display memory for a second display 420 virtually positioned vertically next to first display 410. Thus, where virtual display 400 is defined to be of a dimension X-width and Y-height, the memory buffer is a size X*2Y. It should be noted that while virtual display 400 is shown as a rectangular memory area, that a linear or other memory area of the above mentioned size may be utilized in accordance with different embodiments of the present invention. Virtual display 400 is defined within memory buffer 220 as a single wide, double high display.

In combination with virtual display 400, LCD driver 215 is programmed by processor 230 to operate on a double buffered single wide, single high displays. This causes LCD driver 215 to assert a horizontal sync at the end of each display line (i.e., addresses x), and to assert a vertical sync at the end of each of the double buffers (i.e., addresses [x−1, y−1] and [x−1, 2y−1]). In such a configuration, the display data and the horizontal sync timing signal are provided directly from LCD driver 215 to display 245 and display 250. In contrast, the display clock and the vertical sync timing signals from LCD driver 215 are provided indirectly to display 245 and display 250 via splitter logic circuit 240. In operation, the display clock is passed to display 245 while addresses associated display memory 410 are accessed and gated from display 250 for the same period, and passed to display 250 while addresses associated display memory 420 are accessed and gated from display 245 for the same period. Similarly, a vertical sync generated for the end of display memory 410 (i.e., address [x−1, y−1]) is passed to display 245, and a vertical sync generated for the end of display memory 410 (i.e., address [x−1, y−1]) is passed to display 250.

Again, it should be noted that some displays may effectively ignore the display clock when horizontal and vertical syncs are not received. For example, a display may clock in a defined number of display data (i.e., pixels) after reception of a horizontal sync, but ignore display data received in excess of the defined number. In such a circumstance, it may not be necessary to gate the display clock to the particular display. Alternatively, in some cases a display may ignore horizontal and vertical syncs that are not received with an active display clock. In such instances, by gating the display clock to a particular display it would not be necessary to also gate the horizontal and vertical syncs to the display. The aforementioned embodiments of the present invention may be described as having a device splitter that asserts a first vertical sync for the first display upon a first assertion of the virtual vertical sync and asserts a second vertical sync for the second display upon a second assertion of the virtual vertical sync. Such language is used in its broadest sense to mean any situation where a vertical sync is alternated between multiple displays. Thus, this may include, but is not limited to: (1) asserting the vertical sync to display 245 on one assertion of the vertical sync provided by LCD driver 215 and not to display 250, and asserting the vertical sync to display 250 on a subsequent assertion of the vertical sync provided by LCD driver 215 and not to display 245; (2) providing the display clock from LCD driver 215 to display 245 during one assertion of the vertical sync and gating the display clock to display 250 during the same period, and providing the display clock from LCD driver 215 to display 250 during a subsequent assertion of the vertical sync and gating the display clock to display 245 during the same period; and (3) gating both the vertical sync and the display clock to display 245 during one period and not to display 250 during the same period, and gating both the vertical sync and the display clock to display 250 during a subsequent period and not to display 245 during the same period. Based on the disclosure provided herein, one of ordinary skill in the art will recognize a variety of other approaches that may be used to assert a vertical sync to one device and not the other, and then asserting the vertical sync to the other display during a subsequent period.

Turning to FIG. 4b, a flow diagram 401 graphically displays the above described process. Following flow diagram 401, memory buffer 220 is provisioned to hold a double buffered X*Y memory (i.e., X*2Y) (block 406). This is a single wide, double high virtual display. In addition, LCD driver 215 is programmed to treat virtual display 400 as a double buffered single wide, single high display (block 411). The memory address to memory buffer 220 is reset to the beginning of display memory 410 (block 416). Display data from the beginning address is then read from memory buffer 220 and provided to both display 245 and display 250 (blocks 421, 426). The display clock is, however, only passed through to display 245 during access to display memory 410 and only to display 250 during access to display memory 250. It is then determined whether the address is the last address in a line of virtual display 300 (i.e., x−1) (block 431). Where it is determined that the address is not the last address in a line (block 431), the address is incremented (block 471), and the next display data is read from memory buffer 220 (block 421). Where it is determined that the address is the last address in the line (block 431), it is determined whether the address is the last address of display memory 410 (block 436). Where it is determined that the address is the last address of display memory 410 (block 436), both a horizontal sync and a vertical sync is applied to display 245 (block 456), the address is incremented (block 471), and the next display data is read from memory buffer 220 (block 421). Alternatively, where it is determined that the address is not the last address of display memory 410 (block 436), it is determined whether the address is within display memory 410 or display memory 420 (i.e., whether the address is less than y−1) (block 441). Where it is determined that the address is within display memory 410, a horizontal sync is asserted to display 245 (block 461), the address is incremented (block 471), and the next display data is read from memory buffer 220 (block 421). Alternatively, where it is determined that the address is not within display memory 410 (block 441), it is determined whether the address is the last address in display memory 420 (i.e., address 2y) (block 446). Where it is determined that the address is the last (block 446), a horizontal sync and a vertical sync are asserted to display 250 (block 451), the address is reset (block 416), and the next display data is read from memory buffer 220 (block 421). Alternatively, where it is determined that the address is not the last address in display memory 420 (block 446), a horizontal sync is asserted to display 250 (block 466), the address is incremented (block 471), and the next display data is read from memory buffer 220 (block 421).

As just some of the advantages of the embodiments discussed in relation to FIGS. 4a-4b, LCD driver 215 treats virtual display 400 as one large screen in memory, and provides a relatively simple implementation. It should be noted that the display clock is an Nx clock for a given display refresh rate where N represents the number of displays driven. In some cases, splitter logic circuit 240 may include buffers that may be used to re-time display data and/or timing signals to provide desired setup and hold times in relation to the display clock.

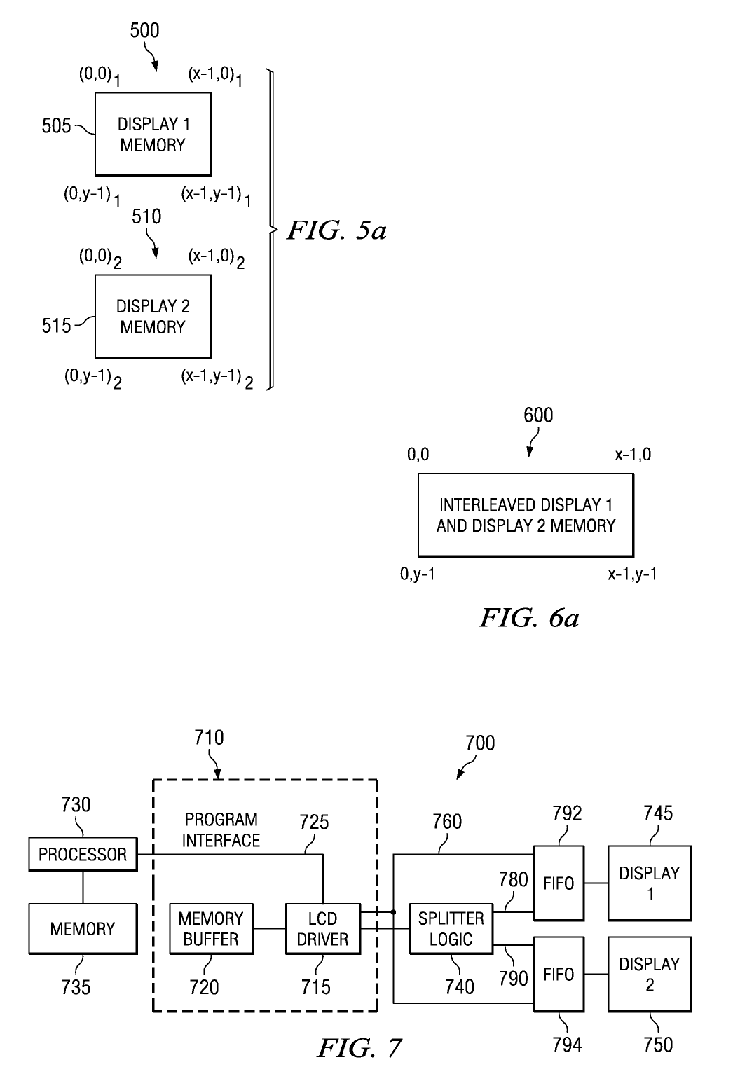

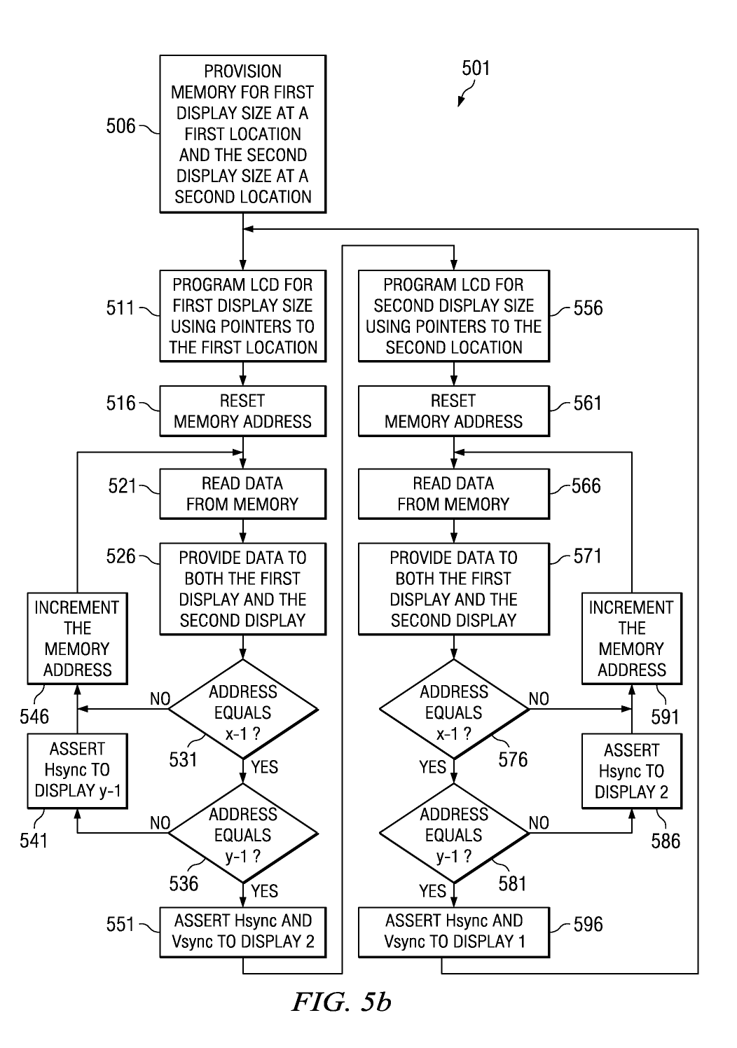

Turning to FIGS. 5a-5b, yet another method in accordance with some embodiments of the present invention for utilizing existing single display driver chip 210 to drive two or more displays is discussed. The method operates through defining a first virtual display 500 and a second virtual display 510. Virtual display 500 is a memory buffer that is defined to maintain a display memory for a first display 505, and a display memory for a second display 515. Both virtual display 500 and virtual display 510 may be maintained in the same memory buffer. It should be noted that while virtual displays 500, 510 are shown as a rectangular memory areas, that a linear or other memory area of the above mentioned size may be utilized in accordance with different embodiments of the present invention. Virtual display 500 and virtual display 510 are defined within memory buffer 220.

In combination with virtual displays 500, 510, LCD driver 215 is repeatedly re-programmed by processor 230 to operate on distinct displays. This causes LCD driver 215 to assert horizontal syncs and vertical syncs tailored for the respective displays. In such a configuration, the display data is provided directly from LCD driver 215 to display 245 and display 250. In contrast, the display clock, the vertical sync, and the horizontal sync timing signals from LCD driver 215 are provided indirectly to display 245 and display 250 via splitter logic circuit 240. In operation, the display clock, the horizontal sync and the vertical sync are passed to display 245 while addresses associated display memory 505 are accessed and gated from display 250 for the same period, and passed to display 250 while addresses associated display memory 515 are accessed and gated from display 245 for the same period.

Turning to FIG. 5b, a flow diagram 501 graphically displays the above described process. Following flow diagram 501, memory buffer 220 is provisioned to hold two distinct memory buffers (block 406). These are virtual displays 500, 510. LCD driver 215 is programmed to drive a display of the same size as virtual display 500 (block 511), and the memory address is reset (block 516). While programmed to drive virtual display 500, the display clock is provided to display 245, and gated from display 250. Display data is read from the memory (block 521) and provided to both display 245 and display 250 (block 526). It is then determined if the address corresponds to the last address in a display line of virtual display 500 (i.e., (x−1)₁) (block 531). Where the address does not correspond to the last address in a display line of virtual display 500 (block 531), the address is incremented (block 546), and the next data is read from memory buffer 220 (block 521). Of note, since the controller is being reprogrammed, each screen may have a buffer at an independent address. Further, the sizes and color depths of the two displays may also be different. Alternatively, where it is determined that the address does correspond to the last address in a display line of virtual display 500 (block 531), it is additionally determined whether the address corresponds to the last address in virtual display 500 (block 536). Where the address does not correspond to the last address in virtual display 500 (block 536), a horizontal sync is asserted to display 245 (block 541), the address is incremented (block 546), and the next data is read from memory buffer 220 (block 521).

Where the address does correspond to the last address in virtual display 500 (block 536), a horizontal sync and a vertical sync are asserted to display 245 (block 551), and LCD driver 215 is re-programmed programmed to drive a display of the same size as virtual display 510 (block 556), and the memory address is reset (block 561). While programmed to drive virtual display 510, the display clock is provided to display 250, and gated from display 245. Display data is read from the memory (block 566) and provided to both display 245 and display 250 (block 571). It is then determined if the address corresponds to the last address in a display line of virtual display 510 (i.e., (x−1)₂) (block 576). Where the address does not correspond to the last address in a display line of virtual display 510 (block 576), the address is incremented (block 591), and the next data is read from memory buffer 220 (block 566). Alternatively, where it is determined that the address does correspond to the last address in a display line of virtual display 510 (block 576), it is additionally determined whether the address corresponds to the last address in virtual display 510 (block 581). Where the address does not correspond to the last address in virtual display 510 (block 581), a horizontal sync is asserted to display 250 (block 586), the address is incremented (block 591), and the next data is read from memory buffer 220 (block 566).

Where the address does correspond to the last address in virtual display 510 (block 581), a horizontal sync and a vertical sync are asserted to display 250 (block 596), and LCD driver 215 is re-programmed programmed to drive a display of the same size as virtual display 500 (block 511), and the memory address is reset (block 516). The process of re-programming LCD driver 215 may be accomplished during a vertical sync period of the particular displays. Such an approach allows for driving two displays with different characteristics.

As just some of the advantages of the embodiments discussed in relation to FIGS. 5a-5b, LCD driver 215 is capable of displays with different characteristics including, but not limited to, display size and display clock rate. In such embodiments, both displays are treated as distinct virtual displays in memory. It should be noted that the display clock is approximately an Nx clock for a given display refresh rate where the number of driven displays is N. In particular cases, the display clock may be N1+N2 and the two displays sizes may be very different. In some cases, a smaller display may require slower clocks than a larger display. It may turn out that the wall clock time is about equivalent to Nx, but two distinct clock frequencies will be required to drive the displays (one frequency for each display). In some cases, splitter logic circuit 240 may include buffers that may be used to re-time display data and/or timing signals to provide desired setup and hold times in relation to the display clock.

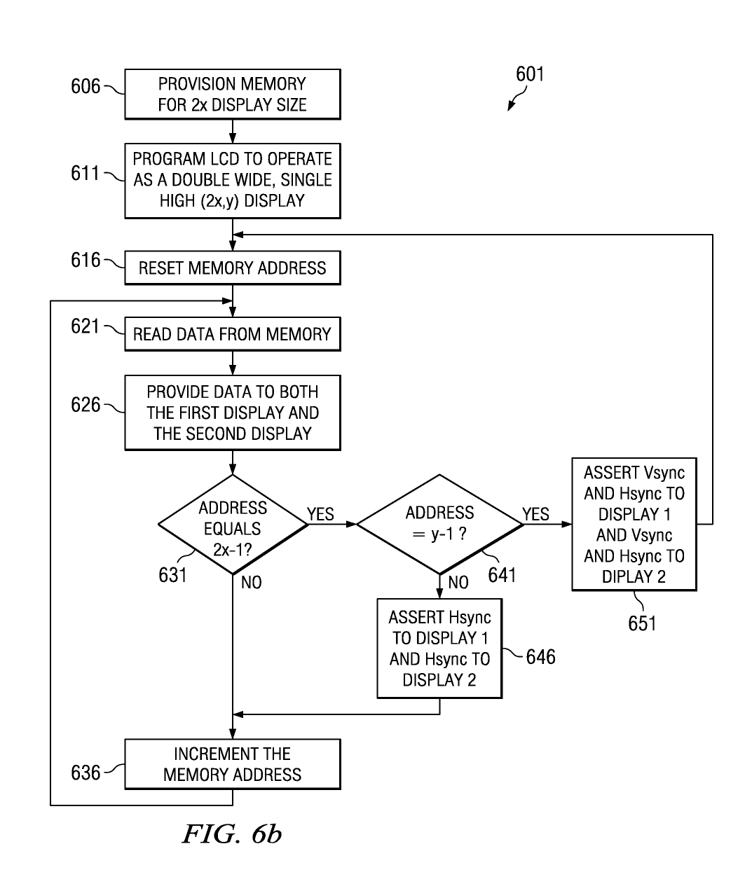

Turning to FIGS. 6a-6b, yet a further method in accordance with one or more embodiments of the present invention for utilizing an existing single display driver chip 210 to drive two or more displays is discussed. The method operates through defining a virtual display 600. Virtual display 600 is a memory buffer that is defined to maintain a display memory for double wide, single high display where data destined for two different displays are interleaved. In one particular embodiment of the present invention, the data destined for the two different displays is interleaved on a pixel by pixel basis. Based on the disclosure provided herein, one of ordinary skill in the art will recognize a variety of other approaches to interleaving that may be used in accordance with different embodiments of the present invention.

In combination with virtual display 600, LCD driver 215 is programmed by processor 230 to operate on a double wide, single high display. This causes LCD driver 215 to assert a horizontal sync at the end of each display line (i.e., addresses [x−1, 0], [x−1, 1] . . . [x−1,y−1]). In such a configuration, the display data, horizontal sync and the vertical sync timing signal are provided directly from LCD driver 215 to display 245 and display 250. In contrast, the display clock is provided indirectly to display 245 and display 250 via splitter logic circuit 240. In operation, the display clock is divided by two with one cycle of the divided display clock being passed to display 245, and the other cycle of the display clock being passed to display 250.

Turning to FIG. 6b, a flow diagram 601 graphically displays the above described process. Following flow diagram 601, memory buffer 220 is provisioned to hold a 2X*Y memory (block 606). This is the double wide, single high virtual display. In addition, LCD driver 215 is programmed to treat virtual display 600 as a unified double wide, single high display (block 611). The memory address to memory buffer 220 is reset to the beginning of virtual display 600 (block 616). Display data from the beginning address is then read from memory buffer 220 and provided to both display 245 and display 250 (blocks 621, 626). The display clock is, however, provided on an alternating basis to display 245 and then to display 250. Thus, for example, the divided display clock is provided to display 245 in association with one display data, to display 250 in association with a succeeding display data, back to display 245 in association with the next succeeding display data, and then back to display 250 in association with the next succeeding display data.

It is determined whether the address is the last address in the line (i.e., address 2x−1) (block 631). Where it is determined that the address is not the last address in the line (block 631), the address is incremented (block 636) and the next display data is read from memory buffer 220 (block 621). In contrast, where it is determined that the address is the last address in the line (block 631), it is determined whether the address is also the last address of virtual display 600 (i.e., 2−1x, y−1) (block 641). Where the address is not the last address of virtual display 600 (block 641), the horizontal sync is passed from LCD driver 215 to both display 245 and display 250 (block 646), the address is incremented (block 636), and the next display data is read from memory buffer 220 (block 621). Alternatively, where it is determined that the address is the last address of virtual display 600 (block 641), the vertical sync and the horizontal sync from LCD driver 215 are passed to both display 245 and display 250 (block 651), and the memory address is reset (block 616).

As just some of the advantages of the embodiments discussed in relation to FIGS. 6a-6b, only a 1x display clock is provided to both displays. It should be noted that special graphics software may be used to interleave the data into virtual display 600. In some cases, splitter logic circuit 240 may include buffers that may be used to re-time display data and/or timing signals to provide desired setup and hold times in relation to the display clock.

It should be noted that in each of the aforementioned embodiments, the display data is provided directly to multiple displays. In some cases, this can resulting problematic setup and hold issues in relation to clocking the display data in to the recipient displays. Thus, some embodiments of the present invention utilize buffers to re-time the display data (e.g., performing line caching) provided to the respective displays. Turning to FIG. 7, a display system 700 including an existing single display driver chip 710 configured to drive two or more displays 745, 750 is shown in accordance with other embodiments of the present invention. Single display driver chip 710 includes an LCD driver 715 and a memory buffer 720 as indicated by the dashed line. LCD driver 715 is programmable by a processor 730 via a program interface 725. Such programming may be accomplished through use of programming approach known in the art and consistent with LCD driver 715, and may be accomplished by executing one or more instructions that are maintained in a memory 735. Such instructions may be executable by processor 730 and/or LCD driver 715, and may be, for example, software or firmware instructions. It should be noted that memory 235 may be any form or combination of computer readable media including, but not limited to, a hard disk drive, a random access memory, a flash memory, a removable magnetic storage media, combinations of he aforementioned and/or the like. LCD driver 715 provides a display output set that includes both a display data portion and one or more timing signals. Such timing signals may include, but is not limited to, a horizontal sync signal, a vertical sync signal and a display clock. Based on the disclosure provided herein, one of ordinary skill in the art will recognize a variety of timing signals and display data that may be included in a display output set provided by LCD driver 715. In different embodiments of the present invention, one portion 760 of the display output set is driven to both display 745 and display 750 via respective FIFO memories 792, 794. Another portion 770 of the display output set is driven indirectly through FIFO memories 792, 794 via a splitter logic circuit 740. FIFO memories 792, 794 may be used to re-time signals from LCD driver 715 to displays 745, 750 as is known in the art. In contrast to that known in the art, one or more of the timing signals from LCD driver 715 may be reformed from a single display format produced by LCD driver 715 to a multiple display format consistent with that discussed above in relation to FIGS. 3-6.

In conclusion, the present invention provides novel systems, devices, methods and arrangements for driving a display. While detailed descriptions of one or more embodiments of the invention have been given above, various alternatives, modifications, and equivalents will be apparent to those skilled in the art without varying from the spirit of the invention. Therefore, the above description should not be taken as limiting the scope of the invention, which is defined by the appended claims.

What is claimed is:

1. An multi-display driver system, wherein the multi-display driver system includes:
a display driver, wherein the display driver provides a display output set;
a processor and a computer readable medium, where the computer readable medium includes instructions executable by the processor to:
configure the display driver to provide the display output set for a virtual display; and
a splitter device, wherein the splitter device is operable to:
receive at least a portion of a display output set; and
based on the portion of the display output set, provide a first display output to drive a first display and a second display output to drive a second display.

2. The system of claim 1, wherein the display driver is capable of driving only a single display.

3. The system of claim 1, wherein the display output set includes display data, and wherein the splitter device includes a first FIFO memory for storing a first portion of the display data for the first display and a second FIFO memory for storing a second portion of the display data for the second display.

4. The system of claim 1, wherein the virtual display is a double wide, single high display, and wherein configuring the display driver to provide the display output set for the virtual display includes configuring the display driver to drive a single wide, double high display.

5. The system of claim 4, wherein the display output set includes a virtual horizontal sync, and wherein the device splitter asserts a first horizontal sync for the first display upon a first assertion of the virtual horizontal sync and asserts a second horizontal sync for the second display upon a second assertion of the virtual horizontal sync.

6. The system of claim 1, wherein the virtual display is a single wide, double high display, and wherein configuring the display driver to provide the display output set for the virtual display includes configuring the display driver to drive a double buffered single wide, single high display.

7. The system of claim 6, wherein the display output set includes a virtual vertical sync, and wherein the device splitter asserts a first vertical sync for the first display upon a first assertion of the virtual vertical sync and asserts a second vertical sync for the second display upon a second assertion of the virtual vertical sync.

8. The system of claim 1, wherein the display output set includes a virtual horizontal sync and a virtual vertical sync, wherein the virtual display is a first virtual display, and wherein the computer readable medium further includes instructions executable by the processor to:
re-configure the display driver to provide the display output set for a second virtual display upon a preceding assertion of the virtual vertical sync; and
re-configure the display driver to provide the display output set for the first virtual display upon a subsequent assertion of the virtual vertical sync.

9. The system of claim 8, wherein the device splitter asserts a first vertical sync for the first display that corresponds to the subsequent assertion of the virtual vertical sync, and asserts a second vertical sync for the second display that corresponds to the preceding assertion of the virtual vertical sync.

10. The system of claim 1, wherein the virtual display is a double wide, single high display, and wherein configuring the display driver to provide the display output set for the virtual display includes configuring the display driver to drive a double wide, single high display.

11. The system of claim 10, wherein the display output set includes a virtual display clock, and wherein the device splitter asserts a first display clock for the first display upon a preceding assertion of the virtual display clock and asserts a second display clock for the second display upon a subsequent assertion of the virtual display clock.

12. A method for driving multiple displays, the method comprising:
providing a display driver, wherein the display driver is capable of driving only a single display;
configuring the display driver to provide a display output set for a virtual display; and
based on a portion of the display output set, providing a first display output to drive a first display and a second display output to drive a second display, wherein the display on the first display is different from the display on the second display.

13. The method of claim 12, wherein the virtual display is a double wide, single high display; wherein configuring the display driver to provide the display output set for the virtual display includes configuring the display driver to drive a single wide, double high display; wherein the display output set includes a virtual horizontal sync; wherein providing the first display output includes asserting a first horizontal sync for the first display upon a first assertion of the virtual horizontal sync; and wherein providing the second display output includes asserting a second horizontal sync for the second display upon a second assertion of the virtual horizontal sync.

14. The method of claim 12, wherein the virtual display is a single wide, double high display; wherein configuring the display driver to provide the display output set for the virtual display includes configuring the display driver to drive a double buffered single wide, single high display; wherein the display output set includes a virtual vertical sync; wherein providing the first display output includes asserting a first vertical sync for the first display upon a first assertion of the virtual vertical sync; and wherein providing the second display output includes asserting a second vertical sync for the second display upon a second assertion of the virtual vertical sync.

15. The method of claim 12, wherein the display output set includes a virtual horizontal sync and a virtual vertical sync, wherein the virtual display is a first virtual display, and wherein the method further comprises:
re-configuring the display driver to provide the display output set for a second virtual display upon a preceding assertion of the virtual vertical sync; and
re-configuring the display driver to provide the display output set for the first virtual display upon a subsequent assertion of the virtual vertical sync.

16. The method of claim 15, wherein providing the first display output includes asserting a first vertical sync for the first display that corresponds to the subsequent assertion of the virtual vertical sync; and wherein providing the second display output includes asserting a second vertical sync for the second display that corresponds to the preceding assertion of the virtual vertical sync.

17. The method of claim 12, wherein the virtual display is a double wide, single high display; wherein configuring the display driver to provide the display output set for the virtual display includes configuring the display driver to drive a double wide, single high display; wherein the display output set includes a virtual display clock; wherein providing the first display output includes asserting a first display clock for the first display upon a first assertion of the virtual display clock; and wherein providing the second display output includes asserting a second display clock for the second display upon a subsequent assertion of the virtual display clock.

18. A computer readable medium, wherein the computer readable medium includes instructions executable by a processor to:
configure a display driver to provide a display output set for a virtual display, wherein the display driver is capable of driving only a single display, and wherein the display output is modifiable to drive at least a first display and a second display.

19. The computer readable medium of claim 18, wherein the virtual display is a double wide, single high display; wherein configuring the display driver to provide the display output set for the virtual display includes configuring the display driver to drive a double wide, single high display; wherein the display output set includes a virtual display clock that is asserted to the first display on one cycle and to the second display on another cycle.

20. The computer readable medium of claim 18, wherein the virtual display is a double wide, single high display; wherein configuring the display driver to provide the display output set for the virtual display includes configuring the display driver to drive a single wide, double high display; wherein the display output set includes a virtual horizontal sync; and wherein the virtual horizontal sync is asserted to the first display on one cycle and to the second display on another cycle.
